(19) United States
(12) Patent Application Publication
(10) Pub. No.: US 2019/0190409 A1
(43) Pub. Date: Jun. 20, 2019

(54) MOTOR DRIVER

(71) Applicant: DENSO CORPORATION, Kariya-city (JP)

(72) Inventor: Takashi IMURA, Kariya-city (JP)

(21) Appl. No.: 16/193,093

(22) Filed: Nov. 16, 2018

(30) Foreign Application Priority Data
Dec. 14, 2017 (JP) 2017-239528

(51) Int. Cl. H02P 6/10; H02M 3/158; H02M 7/5387; H02M 1/14

(52) U.S. Cl. CPC H02P 6/10; H02M 3/1582; H02M 2001/0009; H02M 1/14; H02P 2201/07; H02M 7/5387

(57) ABSTRACT

A motor driver drives a motor by receiving a power supply from a direct current power source, and includes a half-bridge circuit, a smoothing capacitor, a power supply circuit, a current adjuster circuit, and a control circuit. The half-bridge circuit and the smoothing capacitor are connected at positions between a power supply line and a ground line. The current adjuster circuit adjusts a current supply amount to the power supply circuit. The control circuit controls the half-bridge circuit and the current adjuster circuit. The control circuit controls the current adjuster circuit based on an operating state of the half-bridge circuit.

### CROSS REFERENCE TO RELATED APPLICATION

The present application is based on and claims the benefit of priority of Japanese Patent Application No. 2017-239528, filed on Dec. 14, 2017, the disclosure of which is incorporated herein by reference.

### TECHNICAL FIELD

The present invention generally relates to a motor drive device, or a motor driver, that receives a power supply from a direct current (DC) power source through a pair of DC power supply lines and drives a motor.

### BACKGROUND INFORMATION

A motor driver may be used to drive a motor mounted on a vehicle by receiving a power supply from a direct current (DC) power source such as a battery via a pair of DC power supply lines. Such a motor driver may have a half-bridge circuit composed of two switching elements connected in series at a position between the DC power supply lines, and may be configured to adjust a winding current of the motor by switching the drive of these switching elements.

The switching of the switching elements may cause an increase in current fluctuations flowing through the motor drive and cause ripple that may lead to an unstable operation of the motor driver. As such, motor drivers are subject to improvement.

### SUMMARY

The present disclosure describes a motor driver capable of suppressing a fluctuation in an electric current flowing through the motor driver while minimizing the size of a smoothing capacitor smoothing the voltage input to the motor driver.

### BRIEF DESCRIPTION OF THE DRAWINGS

Objects, features, and advantages of the present disclosure will become more apparent from the following detailed description made with reference to the accompanying drawings, in which:

FIG. 1 illustrates a configuration of a motor-inverter in a first embodiment of the present disclosure;

FIG. 2 illustrates a block diagram of a current adjuster circuit in the first embodiment;

FIG. 3 is a time chart of an electric current and a voltage in various parts of the configuration in the first embodiment;

FIG. 4 illustrates a relation between capacitance and a breakdown voltage in the first embodiment:

FIG. 5 illustrates a configuration for driving a half-bridge circuit as part of a control circuit in the first embodiment:

FIG. 6 is a time chart of signals for the control circuit in the first embodiment:

FIG. 7 illustrates a configuration of the motor-inverter in a second embodiment of the present disclosure;

FIG. 8 is a flowchart of control performed by the control circuit in the second embodiment;

FIG. 9 illustrates a configuration of the motor-inverter in a third embodiment of the present disclosure;

FIG. 10 is a time chart of an electric current and a voltage in various parts of the configuration in the third embodiment;

FIG. 11 illustrates a configuration for driving the half-bridge circuit as part of a control circuit in a fourth embodiment of the present disclosure; and

FIG. 12 is a flowchart of control performed by the control circuit in the fourth embodiment of the present disclosure.

### DETAILED DESCRIPTION

Hereinafter, embodiments of the present disclosure are described with reference to the drawings. In the following description of the embodiments, like elements and features between the different embodiments may be referred to by the same reference characters and repeat descriptions of the like elements and features may be omitted.

### First Embodiment

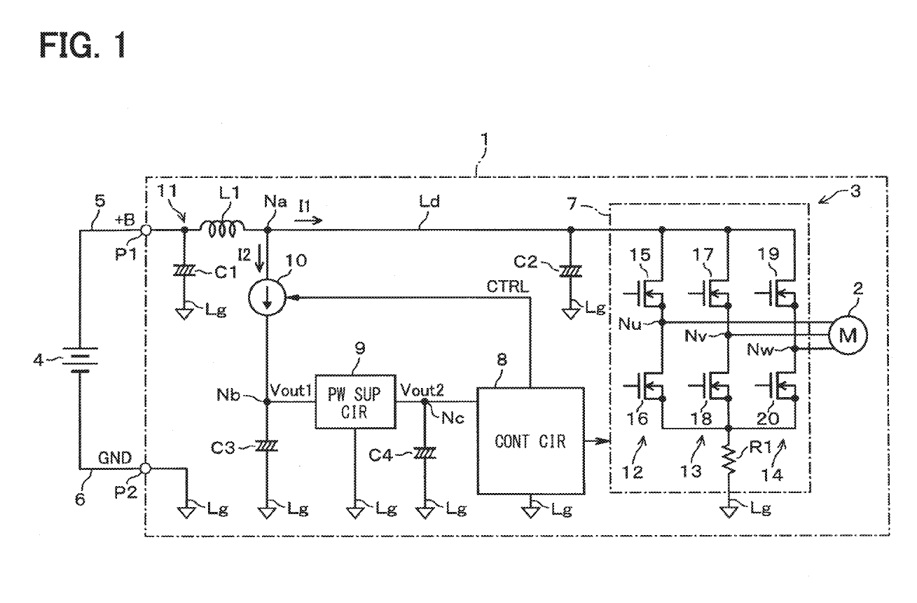

The first embodiment of the present disclosure is described with reference to FIGS. 1 to 6.

With reference to FIG. 1, a motor-inverter 1 may include a motor 2 and a motor driver 3. The motor 2 may be disposed in a vehicle (not shown). The motor 2 may be, for example, an electric motor of an engine cooling fan, radiator cooling fan, or other cooling fan. The motor driver 3 receives a power supply to drive the motor 2 from a direct current (DC) power source 4 via a pair of DC power supply lines 5 and 6. The DC power source 4 may be, for example, an in-vehicle battery that supplies electric power to the motor driver 3 via the terminals P1 and P2. The terminal P2 may be connected to a ground line Lg or like return path to provide a reference potential (e.g., 0 V) at a position inside the motor-inverter 1.

The motor driver 3 includes capacitors C1, C2, C3, and C4, an inductor L1, an inverter main circuit 7, a control circuit 8, a power supply circuit 9, and a current adjuster circuit 10. The capacitor C1 is connected at a position between the terminal P1 and the ground line Lg. The inductor L1 is connected to a position between the terminal P1 and a node Na. The node Na is connected to the power supply line Ld. The capacitor C1 and the inductor L1 constitute an LC filter 11 for smoothing the voltage between the DC power supply lines 5 and 6.

The power supply line Ld and the ground line Lg correspond to a pair of DC power supply lines. That is, a pair of DC power supply lines may refer to the power supply line Ld and the ground line Lg.

The capacitor C2 is connected to a position between the power supply line Ld and the ground line Lg. The capacitor C2 is a smoothing capacitor for smoothing the input voltage to the inverter main circuit 7. The inverter main circuit 7 converts the DC voltage input via the power supply line Ld and the ground line Lg into a three-phase AC voltage, and outputs the AC voltage. The nodes Nu, Nv, and Nw correspond to the output terminals for each of the three phases of the inverter main circuit 7. The nodes Nu, Nv, and Nw are respectively connected to the corresponding three-phase terminals of the motor 2.

The inverter main circuit 7 includes three leg circuits respectively connected to a position between the power supply line U and the ground line Lg. That is, as the three leg circuits, the inverter main circuit 7 has half-bridge circuits 12, 13, and 14 for each of the three phases. The half-bridge circuit 12 includes two switching elements 15 and 16 that may be n-type power MOSFETs (e.g., n-type metal-oxide semiconductor field effect transistors). The switching element 15 connected on the high side (e.g., voltage receiving side) of the half-bridge circuit 12 may be referred to as being on the upper arm of the half-bridge circuit 12. The switching element 16 connected on the low side (e.g., the voltage return path side) of the half-bridge circuit 12 may be referred to as being on the lower arm of the half-bridge circuit 12. When the switching elements 15 and 16 are configured as n-type MOSFETs, the drain of the switching element 15 is connected to the power supply line Ld, and the source of the switching element 15 is connected to the node Nu. The drain of the switching element 16 is connected to the node Nu and the source of the switching element 16 is connected to the ground line Lg via a resistor R1. The resistor R1 may be a shunt resistor used for current detection. That is, the resistor R1 may be used to measure the current in the inverter main circuit 7.

The half-bridge circuit 13 includes two switching elements 17 and 18 that may be, for example, power MOSFETs. In the example shown in FIG. 1, the switching elements 17 and 18 are n-type MOSFETs. The drain of the switching element 17 on the upper arm of the half-bridge circuit 13 is connected to the power supply line Ld. and the source of the switching element 17 is connected to the node Nv. The drain of the switching element 18 on the lower arm of the half-bridge circuit 13 is connected to the node Nv, and the source of the switching element 18 is connected to the ground line Lg via the resistor R1.

The half-bridge circuit 14 includes two switching elements 19 and 20 that may be, for example, power MOSFETs. In the example shown in FIG. 1, the switching elements 19 and 20 are n-type MOSFETs. The drain of the switching element 19 on the upper arm of the half-bridge circuit 14 is connected to the power supply line Ld, and the source of the switching element 19 is connected to the node Nw. The drain of the switching element 20 on the lower arm of the half-bridge circuit 14 is connected to the node Nw, and the source of the switching element 20 is connected to the ground line Lg via the resistor R1.

The control circuit 8 controls the drive of the switching elements 15, 16, 17, 18, 19, and 20 in the half-bridge circuits 12, 13, and 14. That is, the operation of the half-bridge circuits 12, 13, and 14, and ultimately, the operation of the inverter main circuit 7 are controlled by the control circuit 8. The control circuit 8 can adjust the winding current in the motor 2 by controlling the switching (e.g., controlling the driving) of the switching elements 15 to 20. In the half-bridge circuits 12, 13, and 14, the upper arm switching element and the lower arm switching element are driven complementarily in an alternating manner. For example, the control circuit 8 may drive the switching element 15 while not driving the switching element 16. The control circuit 8 can also set a dead time for the half-bridge circuits 12, 13, and 14, that is, a period where both switching elements in the half-bridge circuit are turned off.

The power supply circuit 9 may provide power to the control circuit 8, and may be configured as a linear regulator. The power supply circuit 9 operates by receiving a supply of electric current from the power supply line Ld. The power supply circuit 9 steps down the voltage input through a node Nb to a desired voltage value (e.g., from +12 V to +5 V), and outputs the step-down voltage to the control circuit 8 through a node Nc.

The voltage at the node Nb may be referred to as voltage “Vout1,” and the voltage at the node Nc may be referred to as voltage “Vout2.” A capacitor C3 is disposed at a position between the node Nb and the ground line Lg for suppressing fluctuations in the voltage Vout1. A capacitor C4 is disposed at a position between the node Nc and the ground line Lg for suppressing fluctuations in the voltage Vout2.

The current adjuster circuit 10 is disposed at a position between the node Na and the node Nb, that is, between the power supply line Ld and the power supply circuit 9. The current adjuster circuit 10 adjusts the current supply amount from the power supply line Ld to the power supply circuit 9. The operation of the current adjuster circuit 10 is controlled by an instruction signal CTRL provided by the control circuit 8. The control circuit 8 controls the operation of the current adjuster circuit 10 based on the operation state of the half-bridge circuits 12, 13, and 14.

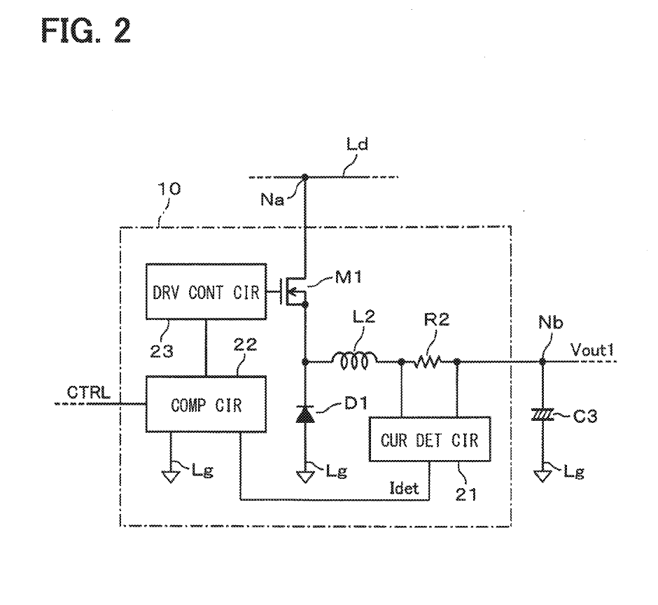

An example configuration of the current adjuster circuit 10 is shown in FIG. 2. The current adjuster circuit 10 may be configured as a switching power supply circuit, or more specifically, as a constant current type step-down switching regulator. The current adjuster circuit 10 may include a transistor M1, a diode D1, an inductor L2, a resistor R2, a current detection circuit 21, a comparator circuit 22, and a drive control circuit 23. The transistor M1 may be an N-channel MOS transistor (e.g., an n-type MOSFET). The resistor R2 is a shunt resistor used for current detection.

The drain of the transistor M1 is connected to the node Na. and the source of the transistor M1 is connected to the node Nb via the inductor L2 and the resistor R2. The cathode of the diode D1 is connected to the source of the transistor M1, and the anode of the diode D1 is connected to the ground line Lg.

The current detection circuit 21 may include an amplifier and a low-pass filter circuit (both not shown). The current detection circuit 21 detects the output current of the current adjuster circuit 10. That is, the current detection circuit 21 detects a charge/discharge current to the capacitor C3 and the current supplied to the power supply circuit 9, based on a terminal voltage of the resistor R2. The current detection circuit 21 outputs a current detection signal Idet corresponding to the detected current to the comparator circuit 22.

The comparator circuit 22 compares the instruction signal CTRL provided by the control circuit 8 with the current detection signal Idet provided by the current detection circuit 21, and outputs a signal representing the comparison result to the drive control circuit 23. A target value of the output current of the current adjuster circuit 10 is represented by the level of the instruction signal CTRL. Based on the output signal of the comparator circuit 22, the drive control circuit 23 controls the driving of the transistor M1 so that the output current of the current adjuster circuit 10 agrees with the target value.

Based on such a configuration of the current adjuster circuit 10, the control circuit 8 can provide instructions to the current adjuster circuit 10 to control the charge/discharge current to the capacitor C3, and the current supplied to the power supply circuit 9 so that these currents match their respective target values.

As described above, the fluctuation of the current flowing through the motor driver 3 is the ripple current. The ripple current is generated due to the consumption current in the inverter main circuit 7, and the consumption current decreases during the dead time when the switching elements in the half-bridge circuits are turned off. Thus, in the present embodiment, by controlling the operation of the current adjuster circuit 10 to increase the consumption current by the power supply circuit 9 when the current flowing from the DC power source 4 to the motor driver 3 decreases, the motor-inverter 1 can limit and/or prevent the generation of the ripple current. In other words, when the current consumed by the inverter main circuit 7 decreases, the control circuit 8 can control the operation of the current adjuster circuit 10 to increase the consumption current in the motor driver 3 to limit and/or prevent the ripple current from occurring.

In the description, and, for example as shown in FIG. 1, the current flowing from the DC power source 4 to the inverter main circuit 7 is referred to as a first current I1. The current consumed by the power supply circuit 9, that is, a current supplied from the power supply line Ld to the power supply circuit 9 via the current adjuster circuit 10 is referred to as a second current I2.

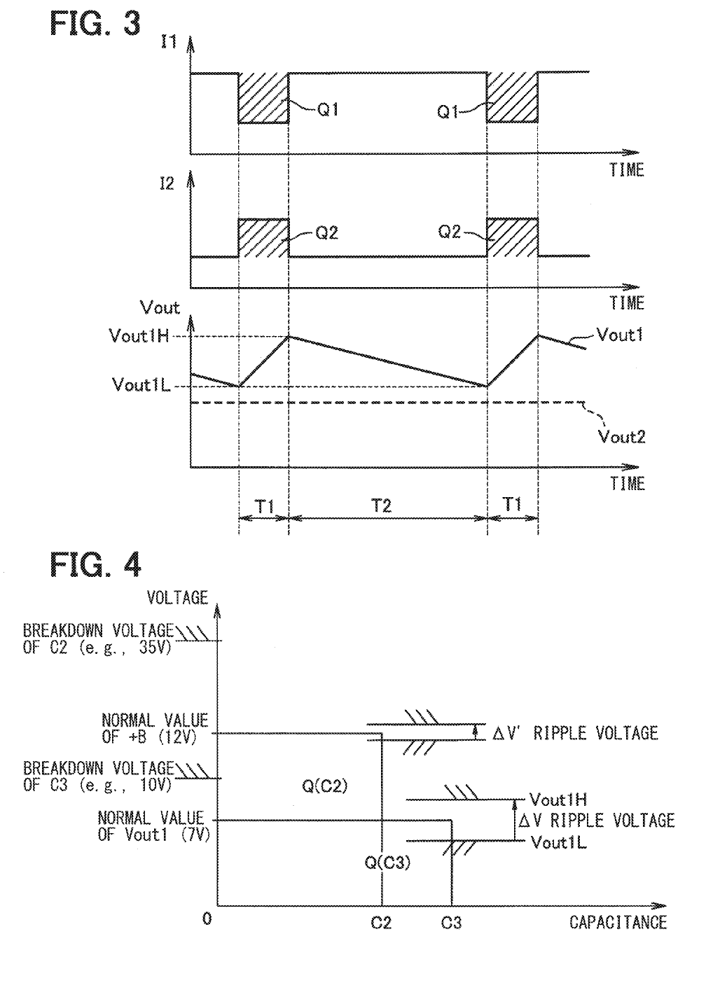

As shown in FIG. 3, the first current I1 decreases in a period T1, which is the dead time, as compared to another period T2. Note that, in FIG. 3, the amount of fluctuation of the consumed electric charge in the inverter main circuit 7 in the period T1 is represented as Q1. Then, by controlling the operation of the current adjuster circuit 10, that is, by performing the current adjustment operation as described above, the second current I2 in the period T1 increases in comparison to the period T2. In FIG. 3, the amount of fluctuation of the consumed electric charge in the inverter main circuit 7 in the period T1 is represented as Q2. In such a way, the decrease in the consumption current in the inverter main circuit 7 during the dead time is compensated by the increase in the consumption current in the power supply circuit 9, and as a result, the fluctuation of the current flowing through the motor driver 3 is suppressed.

However, the ripple current suppression effect is achieved by the above-described current adjustment operation when the following equation (1) is satisfied.

|Q1−Q2|<|Q1| Equation (1)

The left side of the above equation (1) is the absolute value of the difference between the amount of change of consumption electric charge in the inverter main circuit 7 during the dead time and the amount of change of the consumption electric charge in the power supply circuit 9 during the dead time. The absolute value on the left side of equation (1) represents the amount of fluctuation of the consumption current of the motor driver 3 when the current adjustment operation is performed.

On the other hand, the right side of the above equation (1) is the absolute value of the amount of change in the inverter main circuit 7 during the dead time, and this value represents the fluctuation of the consumption current of the motor driver 3 when the current adjustment operation is not performed.

Therefore, when the equation (1) is satisfied, that is, when the left side of the equation (1) is smaller than the right side, the ripple current suppression effect is achieved. That is, when the fluctuation of the consumption current of the motor driver 3 is smaller when the current adjustment operation is performed than the consumption current when the current adjustment operation is not performed, the ripple current suppression effect is achieved.

Therefore, in the present embodiment, the current adjustment operation is configured to be performed to satisfy the condition represented by the equation (1).

In the present embodiment, the control circuit 8 switches the target value of the output current indicated by the instruction signal CTRL in multiple stages, for example, in two stages. As such, the current adjuster circuit 10 has a plurality of operating modes (e.g., two) having respectively different current supply amounts from the power supply line Ld to the power supply circuit 9.

The control circuit 8 switches the operating modes of the current adjuster circuit 10 depending on whether both of the switching elements in the upper and lower arms of the half-bridge circuits 12, 13, and 14 are off. That is, the control circuit 8 switches the operating modes of the current adjust circuit 10 depending on whether the two switching elements in the half-bridge circuits 12, 13, and 14 are in the dead time. In such case, the target value of the output current is specified as two values, that is, a limit value I2H and a limit value I2L, where the limit value I2L is smaller than the limit value I2H. More specifically, the control circuit 8 switches the target value of the output current to the limit value I2H during the dead time period, and switches the target value of the output current to the limit value I2L during periods other than the dead time.

The above-described limit values I2H and I2L are set in the following manner. That is, in the above configuration, a charge current Ic and a discharge current Id of the capacitor C3 are represented respectively by the equations (2) and (3). The constant current of the control circuit 8, that is, the output current of the power supply circuit 9, is represented as Iout.

Ic=I2H−Iout Equation (2)

Id=I2L−Iout Equation (3)

A relationship between the period T1, which is the dead time, the period T2 other than the dead time, the charge current Ic of the capacitor C3, and the discharge current Id is represented by the following equation (4).

Ic=(T2/T1)−Id Equation (4)

The voltage Vout1 may include a maximum value Vout1H and a minimum value Vout1L that are used to satisfy equation (5). The capacity of the capacitor C3 is represented as C3.

Vout1H−Vout1L=Ic·T1/C3 Equation (5)

Based on the above equations, the limit values I2L and I2H are set such that the maximum value Vout1H becomes equal to or lower than the upper limit value of the input voltage of the power supply circuit 9, and the minimum value Vout1L becomes equal to or higher than the lower limit value of the input voltage of the power supply circuit 9.

In view of the above condition, in the present embodiment, the limit values I2L and I2H are set to values respectively represented by the equations (6) and (7).

I2L=0 Equation (6)

I2H=C3·(1−T1/T2)·(Vout1H−Vout1L)/T2 Equation (7)

By setting the limit values I2L and I2H based on the equations (6) and (7), the decrease in the consumption current in the inverter main circuit 7 during the dead time may be compensated by the increase in the consumption current in the power supply circuit 9.

Based on the above description and as shown in FIG. 3, the voltage Vout1 starts to increase when the period T2 transitions to the period T1. The voltage Vout1 starts to decrease when the period T1 transitions to the period T2. FIG. 3 also illustrates the maximum value Vout1H and the minimum value Vout1L, that is, the desired values of Vout1H and Vout1L that may be set to satisfy the above-described equations.

In the above configuration, since the capacitor C3 may have a relatively large charge (Ic)/discharge current (Id), it may be necessary to use a capacitor having a small equivalent series resistance (ESR). However, the capacitor C3 is not connected to the power supply line Ld, that is, where the voltage Vout1 stepped down by the current adjuster circuit 10 is applied. Therefore, as shown in FIG. 4, the breakdown voltage of the capacitor C3 can be set to a comparatively low value reserving a small margin (e.g., 10 V) with respect to the constant normal voltage value of the voltage Vout1 (e.g., 7 V). Therefore, the capacitor C3 may be a small-sized capacitor having a very small ESR, such as a polymer capacitor or a ceramic capacitor.

In the above-described configuration, the ripple voltage ΔV′ at the node Na is limited from having a large value, since the ripple voltage ΔV′ may adversely affect the conduction emission noise to the wire harness for connecting the DC power source 4 and the motor-inverter 1, as well as adversely affecting the voltage feedback control system of the motor 2. As such, it may be necessary for the capacitor C2 to have a relatively large capacitance to limit the ripple voltage ΔV′ at the node Na.

In such a case, additional resistance may be provided to protect against surges (e.g., voltage spikes) since the capacitor C2 is connected to the DC power supply line 5 via the inductor L1. Therefore, as shown in FIG. 4, the breakdown voltage of the capacitor C2 may be set to a value (e.g., 35 V) reserving a sufficient margin with respect to the constant normal voltage value (e.g., 12 V) of the voltage +B of the DC power source 4. As such, an electrolytic capacitor, for example, may be used as the capacitor C2.

However, in the configuration of the present embodiment, the capacitor C3, in addition to the capacitor C2, may provide some contribution to reducing the ripple. Therefore, because the capacitor C3 may also contribute to reducing the ripple, the capacitance of the capacitor C2 may be set to a smaller value than in instances where the ripple is reduced by the capacitor C2 alone. Both the capacitors C2 and C3 may be connected at positions between the power supply line Ld and the ground line Lg.

The configuration of the motor-inverter 1 in the present embodiment may have many advantages over conventional motor-inverters. In the conventional configuration, since the ripple is suppressed by the capacitor C2 alone, the capacitance of the capacitor C2 is set to a value that can suppress the fluctuation of the input voltage of the inverter main circuit 7 to be within an allowable range, and such capacitance can be a very large value. When the fluctuation of the input voltage of the inverter main circuit 7 is large, not only does the EMC performance deteriorate, but a deterioration in the controllability and the stability of the motor 2 may also be observed due to the use of the monitoring result of the input voltage of the inverter main circuit 7 as a feedback control for the motor 2. That means, that the allowable range of the input voltage fluctuation described above is narrow.

In such a case, a current including the ripple component flows in the capacitor C2, resulting in both a power loss in the capacitor C2 and the internal heating of the capacitor C2 caused by such ripple. Therefore, in a conventional configuration where the ripple is absorbed by the capacitor C2 alone, a plurality of capacitors may have to be connected in parallel at a position between the power supply line Ld and the ground line Lg in consideration of the life of those capacitors, thereby increasing the number of capacitors for absorbing the ripple.

In contrast, in the configuration of the present embodiment, the capacitor C3 may be provided with a capacitance value for suppressing the fluctuation of the voltage Vout1, that is, for suppressing the ripple voltage ΔV (=Vout1H−Vout1L) to be within the allowable input range of the power supply circuit 9 in the latter stage. For this range of ripple voltage ΔV, it may be sufficient to satisfy only the operating range of the power supply circuit 9, which may allow for a wider range in comparison to the allowable range of the ripple voltage ΔV′. As such, the capacitor C3 may be implemented as a capacitor with a relatively small capacitance and a relatively low breakdown voltage, as described above, and it is therefore possible to use a smaller-sized capacitor for the capacitor C3.

In the configuration of the present embodiment, the function of suppressing the fluctuation of the input voltage to the inverter main circuit 7, that is, the ripple absorption function, is not borne by the capacitor C2 alone, but rather borne by both of the capacitors C2 and C3 in a sharing manner. Therefore, in the present embodiment, as shown in FIG. 4, the capacitance of the capacitor C2 can be reduced to a smaller value than the conventional configuration, due to sharing the ripple absorption function with the capacitor C3. As a result, in the present embodiment, a capacitor with a lower capacitance may be used as the capacitor C2.

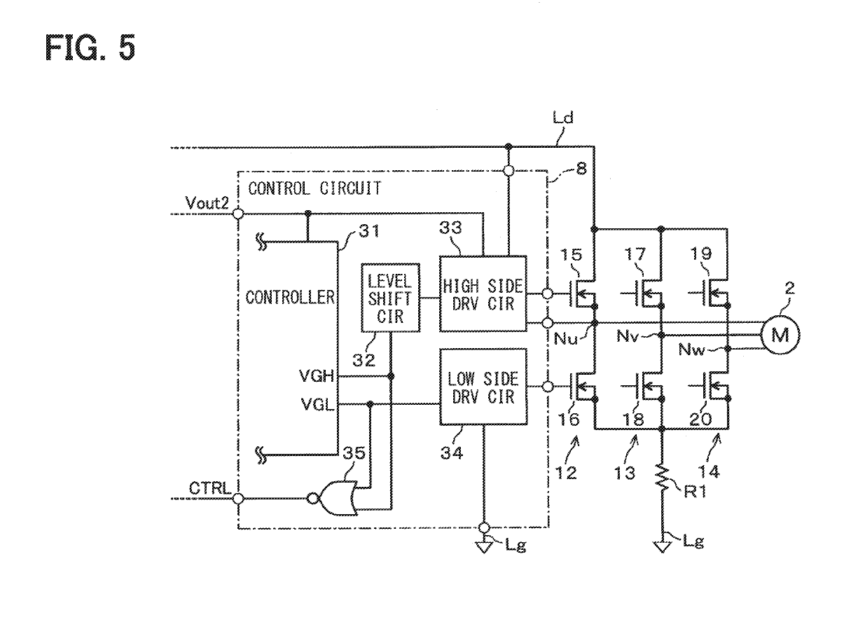

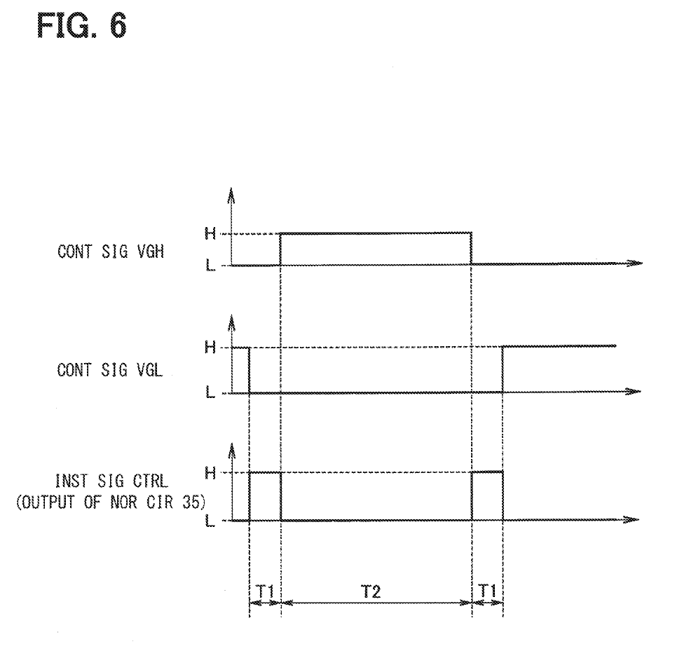

An example configuration of the control circuit 8 for driving the half-bridge circuits 12, 13, and 14 is described with reference to FIGS. 5 and 6. A configuration for driving the half-bridge circuit 12 will be described as an example, suggesting that the same or similar configuration may be used for driving the half-bridge circuits 13 and 14.

The control circuit 8 may include a controller 31, a level shift circuit 32, a high side drive circuit 33, a low side drive circuit 34, and a NOR circuit 35. The NOR circuit 35 may also be referred to as a NOR gate 35.

The controller 31 of the control circuit 8 may include a CPU or like processor, a memory, and one or more inputs/outputs (I/Os). The processor of the controller 31 may be configured to execute a program or instruction set stored in the memory of the controller 31. The execution of the program/instruction set by the CPU of the controller 31 may cause the controller 31 and other components in the control circuit 8 to perform the processes in the process/instruction set. The memory may be, for example, a RAM, a ROM, and a flash memory, and the memory is a substantive, non-transitory computer readable medium for storing programs, instruction sets, data, and other information.

The controller 31 outputs a control signal VGH for controlling the drive of the switching element 15 and outputs a control signal VGL for controlling the drive of the switching element 16. As shown in FIG. 6, both of the control signals VGH and VGL rise to an H level (e.g., 5 V) when the switching elements 15 and 16 are driven to turn on, and fall to an L level (e.g., 0 V) when the switching elements 15 and 16 are turned off.

The level shift circuit 32 outputs a signal obtained by level-shifting the control signal VGH to the high side drive circuit 33. The high side drive circuit 33 drives the switching element 15 based on the level-shifted control signal VGH. The low side drive circuit 34 drives the switching element 16 based on the level-shifted control signal VGL.

The VGH control signal is provided to one input terminal of the NOR gate 35, and the VGL control signal is provide to another input terminal of the NOR gate 35. As shown in FIG. 6, the output signal of the NOR circuit 35 rises to an H level (e.g., +5 V) during the period T1, which is the dead time, and falls to an L level (e.g., 0 V) during the period T2, which is a period other than the dead time (e.g., a period where at least one of the switching elements in the half-bridge circuit is driven). The output signal of the NOR gate 35 may be used as an instruction signal CTRL and provided to the current adjuster circuit 10. In such a case, when an H level instruction signal CTRL is provided, the current adjuster circuit 10 switches the target value of the output current to the limit value I2H, and when an L level instruction signal CTRL is provided, the current adjuster circuit 10 switches the target value of the output current to the limit value I2L.

The following effects are achievable by the present embodiment.

The motor driver 3 of the present embodiment includes the current adjuster circuit 10 that adjusts the amount of electric current supplied from the power supply line Ld to the power supply circuit 9. The control circuit 8 controls the operation of the current adjuster circuit 10 based on the operating state of the half-bridge circuits 12, 13, and 14. More specifically, when the current supplied from the half-bridge circuits 12, 13, and 14 to the motor 2 decreases, the control circuit 8 controls the current adjuster circuit 10 to increase the current supply to the power supply circuit 9. In such a way, the decrease in the electric current supplied to the motor 2 is compensated by the increase in the current supply to the power supply circuit 9. As a result, the fluctuation in the current flowing through the motor driver 3 is suppressed.

Based on the configuration of the present embodiment, it is possible to reduce and/or prevent the fluctuation of the current during the dead time when both of the switching elements in the half-bridge circuit are turned off, without having to increase the capacitance of the smoothing capacitor C2. As such, in present embodiment, the capacitance of the smoothing capacitor C2 can be reduced, while still able to suppress (e.g., limit and/or prevent) the fluctuation of the electric current flowing in the motor driver 3. Since the capacitance of the capacitor C2 can be reduced, a smaller sized capacitor can be used for the capacitor C2. The manufacturing cost of the motor driver 3 can be further reduced with a smaller capacitor C2, and the physical size/volume (e.g., footprint) of the driver 3 can also be reduced. As such, such size and cost reductions may be very advantageous for the manufacture and commercialization of the driver 3.

The current adjuster circuit 10 of the present embodiment has a plurality of operating modes with each mode supplying a different amount of current. The control circuit 8 controls the current adjuster circuit 10 to switch between the different operating modes based on whether it is a dead time, that is, a period when the switching elements in the upper and lower arms of the half-bridge circuits 12, 13, and 14 are turned off. Specifically, the control circuit 8 switches to one operating mode where the current supply amount is relatively high in the period T1 (i.e., the dead time), and the control circuit 8 switches to another operating mode when the current supply amount is relatively low in the period T2, i.e., in a period other than the dead time.

Determining whether the half-bridge circuits 12, 13, and 14 are in a dead time can be easily determined based on the binary control signals VGH and VGL output from the controller 31 of the control circuit 8, that is, based on the signal output level from the NOR gate 35. In such a case, the operation mode of the current adjuster circuit 10 can be switched based on the instruction signal CTRL that is output by the NOR gate 35. In such a way, it is possible to reliably and easily switch the operating mode of the current adjuster circuit 10 while limiting the effect of noise and other unwanted signals during the switching process.

The current used to compensate for the decrease in the current that is supplied from the inverter main circuit 7 to the motor 2 is the current supplied to the power supply circuit 9 to generate the operating power supply of the control circuit 8. That is, in the present embodiment, by adjusting the supply amount of the electric current, the fluctuation of the current flowing through the motor driver 3, that is, the ripple, can be absorbed. It is therefore possible to suppress the fluctuation of the current flowing through the motor driver 3 without unnecessarily increasing the power consumption of the entire motor driver 3.

In addition, the current adjuster circuit 10 can be configured as a step-down switching regulator. As such, losses in the current adjuster circuit 10 can be further reduced as compared with instances where the current adjuster circuit 10 is configured as a series regulator, and the power consumption of the motor driver 3 as a whole can be further reduced.

The motor driver 3 of the present embodiment includes, in addition to a smoothing capacitor C2 connected at a position between the power source line Ld and the ground line Lg, a smoothing capacitor C3 connected at a position between the node Nb that is connected to the output of the current adjuster circuit 10 and the ground line Lg. The following effects may be achieved based on such a configuration. That is, by using the above configuration, the capacitance of the capacitor C2 can be reduced. As such, when the motor-inverter 1 begins its operation and the motor driver 3 is first started, the charge current (e.g., rush current) from the DC power source 4 for charging the capacitor C2 to the voltage +B (e.g., 12 V) can be reduced to a smaller current value.

In such a case however, in order to charge the capacitor C3, an instruction signal is provided by an electronic control unit (ECU)(not shown) outside the motor-inverter 1 to the current adjuster circuit 10 during the startup time of the motor-inverter 1. In such manner, the capacitor C3 can be charged at a startup time by the DC current flowing from the DC power source 4 via the current adjuster circuit 10. That is, at the startup time, a charge current (e.g., a rush current) for charging the capacitor C3 may also be provided from the DC power source 4. However, since the charge current for charging the capacitor C3 is limited to a certain constant current value by the current adjuster circuit 10, the charge current is not excessive.

Thus, based on the configuration of the present embodiment, the rush current at the startup time can be further reduced compared to a conventional configuration where the ripple is absorbed by the capacitor C2 alone. As such, using the configuration of the present embodiment, allows the footprint of the motor driver 3 to be further reduced compared to a conventional configuration that requires a pre-charge circuit to suppress the rush current from the DC power supply. In other words, the motor driver 3 of the present embodiment does not require the pre-charge circuit of a conventional motor driver, and thus, can be made smaller (i.e., is smaller in size).

### Second Embodiment

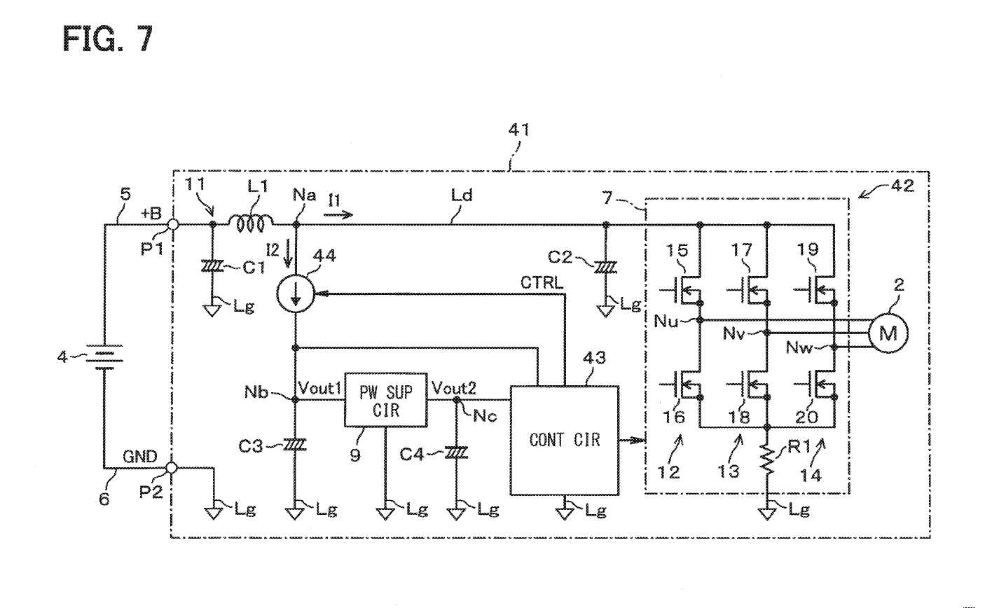

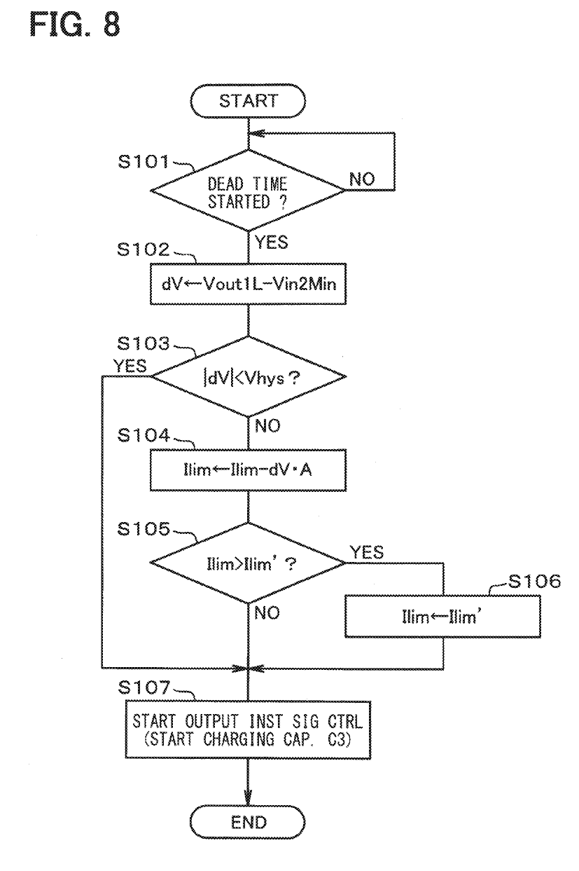

The second embodiment of the present disclosure is described with reference to FIGS. 7 and 8. As shown in FIG. 7, the motor driver 42 of the motor-inverter 41 in the present embodiment is different from the motor driver 3 of the first embodiment in that the motor-inverter 41 includes a control circuit 43 in place of the control circuit 8, and includes a current adjuster circuit 44 in place of the current adjuster circuit 10.

The control circuit 43 monitors the voltage Vout1 of the node Nb. The configuration and the components of the control circuit 43 may be similar to the configuration and the components of the control circuit 8. For example, the control circuit 43 may include all the same components as the control circuit 8 shown in FIG. 5 with the addition of an additional input for monitoring the voltage Vout1 at the node Nb. As such, like components in the control circuit 43 use the same reference characters as those in the control circuit 8 and are described with reference to FIG. 5. The control circuit 43 can control the operation of the current adjuster circuit 44 by using the monitoring result of the voltage Vout1 along with other results. In addition, the current adjuster circuit 44 is configured to switch the output current. That is, the current adjuster circuit 44 is capable of switching the current supply amount from the power supply line Ld to the power supply circuit 9 either in multiple stages (e.g., stepped), or steplessly, based on the instruction signal CTRL provided by the control circuit 43.

Using the above-described configuration, the control circuit 43 can dynamically change the current supply amount to the power supply circuit 9. That is, the control circuit 43 can dynamically change the limit value I2H during the dead time. In the following description, the limit value I2H may also be referred to as a limit value Ilim.

The control process performed by the control circuit 43 is described with reference to FIG. 8.

The control circuit 43 may include a controller 31, described above with reference to the control circuit 8. The controller 31 in the control circuit 43, like the controller 31 in the control circuit 8, may include a CPU or like processor, a memory, and one or more inputs/outputs (I/Os). The processor of the controller 31 may be configured to execute a program or instruction set stored in the memory of the controller 31. The execution of the program/instruction set by the CPU of the controller 31 may cause the controller 31 and other components in the control circuit 43 to perform the processes in the process/instruction set. For example, the controller 31, in addition to other components in the control circuit 43, may perform the process shown in FIG. 8. The memory may be, for example, a RAM, a ROM, and a flash memory, and the memory is a substantive, non-transitory computer readable medium for storing programs, instruction sets, data, and other information. The process in FIG. 8 may be described generally as being performed by the control circuit 43, but this may mean that the controller 31, in addition to other components in the control circuit 43, and the motor-inverter 41, are working together to perform the process in FIG. 8.

When the process shown in FIG. 8 is started, the control circuit 43 determines at S101 whether the dead time has begun (i.e., “DEAD TIME STARTED?” at S101 in FIG. 8). The determination at S101 can be made by detecting that the output signal of the NOR gate 35 has changed from the L level to the H level. That is, the control circuit 43 can detect the rising edge of the output signal of the NOR circuit 35 to determine level change of the output signal. When the control circuit 43 detects that the dead time has started, i.e., “YES” at S101, the process proceeds to S102.

At S102, the control circuit 43 substitutes the variable dV for “Vout1L−Vin2Min,” where dV is a variable for dynamically changing the limit value Ilim. Vout1L is the minimum value of the voltage Vout1, and can be obtained as a result of monitoring the voltage Vout1 described above. Vin2Min represents the lower limit value of the input voltage of the power supply circuit 9. After the control circuit 43 performs S102, the process proceeds to S103, where the control circuit 43 determines whether an absolute value of dV is less than a dead zone Vhys. The dead zone Vhys represents an allowable range of the voltage Vout1 after the capacitor C3 is discharged. That is, whether the voltage Vout1 is considered to be a desired value after the capacitor C3 is discharged, or in other words, within a range of the target value of Vout1.

Here, when the control circuit 43 determines that the absolute value of dV is less than the dead zone Vhys, i.e., “YES” at S103, and the process proceeds to S107. At S107, the control circuit 43 outputs the instruction signal CTRL representing the set limit value Ilim to the current adjuster circuit 44, and the current adjuster circuit 44 accordingly begins to supply the charge current to the capacitor C3 (i.e., “START OUTPUT INST SIG CTRL (START CHARGING CAP. C3)” at S107 in FIG. 8). After the control circuit 43 performs S107, the process comes to an end.

On the other hand, when the control circuit 43 determines that the absolute value of dV is equal to or greater than the dead zone Vhys, i.e., “NO” at S103, the process proceeds to S104. At S104, the control circuit 43 substitutes “Ilim−dV·A” with the limit value Ilim. In other words, the control circuit 43 changes the limit value Ilim. ‘A’ represents a proportional coefficient. At S104, the limit value Ilim is increased or decreased in accordance with the value of dV.

After the control circuit 43 performs S104, the process proceeds to S105, where the control circuit 43 determines whether the limit value Ilim exceeds the limit value Ilim′ (i.e., “Ilim>Ilim′?” at S105 in FIG. 8). The limit value Ilim′ is represented by the following equation (8). The limit value Ilim′ is an upper limit value of the charge current for charging the capacitor C3 in instances where the voltage value of Vout1 will neither reach nor surpass the upper limit value Vin2Max of the input voltage of the power supply circuit 9.

Ilim′=C3·(Vin2Max−Vout1L)/T1 Equation (8)

When the control circuit 43 determines that the limit value Ilim is equal to or less than the limit value Ilim′. i.e., “NO” at S105, the process proceeds to S107. On the other hand, when the control circuit 43 determines that the limit value Ilim exceeds the limit value Ilim′, i.e., “YES” at S105, the process proceeds to S106. At S106, the control circuit 43 substitutes the limit value Ilim′ for the limit value Ilim. That is, the control circuit 43 changes the limit value Ilim to be the limit value Ilim′. After the control circuit 43 performs S106, the process proceeds to S107.

As described above, in the present embodiment, the control circuit 43 dynamically changes the current supply amount to the power supply circuit 9 during the dead time, that is, the control circuit 43 dynamically changes the limit value Ilim. However, the control circuit 43 does not change the limit value Ilim when the minimum value Vout1L of the voltage Vout1 after the capacitor C3 is discharged is a value within a desired/allowable value range. The control circuit 43 changes the limit value Ilim when the minimum value Vout1L is a value outside the allowable value range.

Specifically, the control circuit 43 changes the limit value Ilim as follows. When the dV value obtained by subtracting the lower limit value Vin2Min of the input voltage to the power supply circuit 9 from the minimum value Vout1L is a positive value, the control circuit 43 determines that the capacitor C3 has been charged too much during the dead time. In such a case, the limit value Ilim is changed to decrease by an amount corresponding to dV (=dV·A). In such manner, the minimum value Vout1L becomes smaller, and approaches the lower limit value Vin2Min.

On the other hand, when dV is a negative value, the control circuit 43 determines that the capacitor C3 has been insufficiently charged during the dead time. That is, the control circuit 43 determines that the capacitor C3 has not been charged enough during the dead time. In such a case, the limit value Ilim is changed to increase by an amount corresponding to dV (=dV·A). In such manner, the minimum value Vout1L increases, and approaches the lower limit value Vin2Min.

Further, when the limit value Ilim is changed to increase (i.e., is increasing), the maximum value Vout1H of the voltage Vout1 may exceed the upper limit value Vin2Max of the input voltage to the power supply circuit 9. As a result, the control circuit 43 performs the processes at S105 and S106 to limit the limit value Ilim. According to the present embodiment described above, the advantageous effect of the control circuit 43 reliably maintaining the voltage Vout1 within the desired/allowable value range, is that the fluctuation of the current (e.g., ripple) flowing through the motor driver 42 can be suppressed. As described above, the desirable/allowable range of the voltage Vout1 may be a range defined by (i) a value equal to or lower than the upper limit value of the input voltage to the power supply circuit 9 in the latter stage, and (ii) a value equal to or greater than the lower limit value.

### Third Embodiment

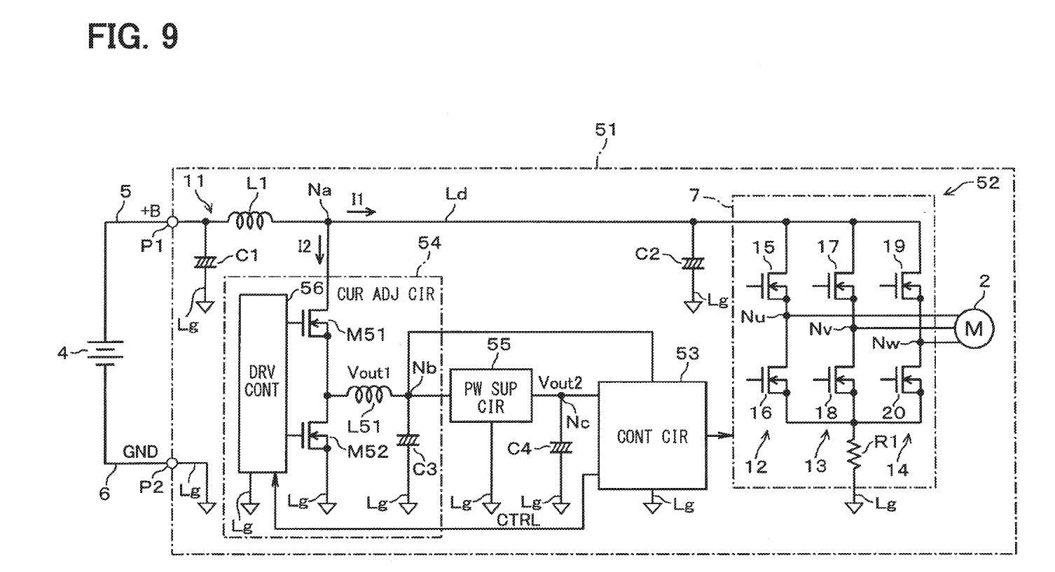

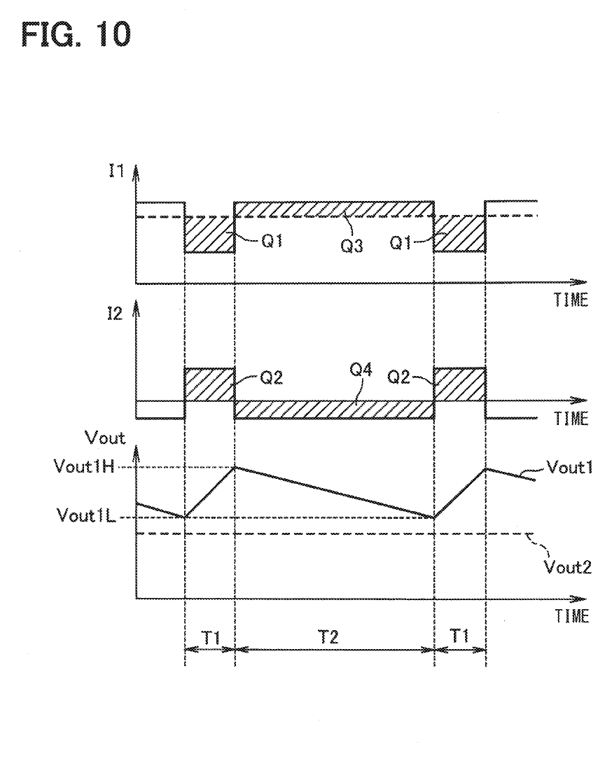

The third embodiment of the present disclosure is described with reference to FIGS. 9 and 10. As shown in FIG. 9, a motor driver 52 of a motor-inverter 51 in the present embodiment is different from the motor driver 3 in the first embodiment in that the motor driver 52 includes a control circuit 53 in place of the control circuit 8, includes a current adjuster circuit 54 in place of the current adjuster circuit 10, and includes a power supply circuit 55 in place of the power supply circuit 9.

The control circuit 53 monitors the voltage Vout1 of the node Nb. The configuration and the components of the control circuit 53 may be similar to the configuration and the components of the control circuit 8. For example, the control circuit 53 may include all the same components as the control circuit 8 shown in FIG. 5 with the addition of an additional input for monitoring the voltage Vout1 at the node Nb. As such, like components in the control circuit 53 use the same reference characters as those in the control circuit 8 and are described with reference to FIG. 5. The processes performed by the control circuit 53 may be performed by the controller 31 in addition to other components in the control circuit 53. The control circuit 53 can control the operation of the current adjuster circuit 54 by using the monitoring result of the voltage Vout1 along with other results. The current adjuster circuit 54 is configured to switch the output current based on the instruction signal CTRL provided by the control circuit 53. That is, the current adjuster circuit 54 is capable of switching the current supply amount from the power supply line Ld to the power supply circuit 55 in a stepwise or stepless manner.

The current adjuster circuit 54 includes transistors M51 and M52, an inductor L51, and a drive controller 56. The transistors M51 and M52 may be N-channel type MOS transistors (e.g., n-type MOSFETs). The drain of the transistor M51 is connected to the node Na, and the source of the transistor M51 is connected to the node Nb via the inductor L51. The drain of the transistor M52 is connected to the source of the transistor M51, and the source of the transistor M52 is connected to the ground line Lg. The drive controller 56 controls the driving of the transistors M51 and M52 (i.e., drives the transistors M51 and M52) based on the instruction signal CTRL provided by the control circuit 53. In the present embodiment, the capacitor C3 is part of the current adjuster circuit 54.

Using such a configuration, the current adjuster circuit 54 of the present embodiment is configured as a bidirectional converter. As such, the current adjuster circuit 54 has (i) a step-down operation mode where the voltage of the power supply line Ld is stepped down and output via the node Nb, and (ii) a step-up operation mode where the voltage of the node Nb is boosted and supplied to the power supply line Ld for regeneration. The power supply circuit 55 supplies operating power to the control circuit 53, and is configured as a step-up/step-down switching regulator.

The control of the current adjuster circuit 54 by the control circuit 53 is described with reference to FIGS. 9 and 10. In this case, the control circuit 53 operates the current adjuster circuit 54 in the step-down operation mode during the period T1, i.e., during the dead time where both the switching elements in the half-bridge circuit are off. In the period T1, an electric current is supplied from the power supply line Ld to the node Nb via the current adjuster circuit 54. As a result, an electric charge Q2 that corresponds to an excessive/surplus charge Q1 on the power supply line Ld in the inverter main circuit 7, is supplied to the node Nb, that is, to the capacitor C3.

The control circuit 53 operates the current adjuster circuit 54 in the step-up operation mode during the period T2, that is, a period other than the dead time. In such manner, in the period T2, an electric current is supplied from the node Nb to the power supply line Ld via the current adjuster circuit 54. As a result, a charge Q3, that corresponds to an excessive/surplus charge Q4 on a node Nb side (e.g, in the capacitor C3) is supplied to the power supply line Ld, that is, to the inverter main circuit 7.

As described above, in the present embodiment, by configuring the current adjuster circuit 54 as a bidirectional converter, the charge utilization rate of the capacitor C3 can be increased. As such, the capacitance of the smoothing capacitor C2 in the present embodiment can be further reduced, since it is possible to exchange charges not only during the dead time, i.e., in the period T1, but also in periods other than the dead time, such as period T2.

Additionally, the power supply circuit 55 can be configured as a step-up/step-down switching regulator. Using such a configuration, the tolerable/allowable range (e.g., tolerance) of the fluctuation of the input voltage of the power supply circuit 55, that is, the fluctuation of the voltage of the node Nb, can be expanded to have a wider value range. As such, it is possible to further reduce the capacitance of the capacitor C3 to have a smaller value than the capacitor C3 described in the first embodiment. As described above, in the present embodiment, it is possible to further reduce the capacitances of the capacitors C2 and C3, thus further reducing the manufacturing cost of the motor driver 52 and further reducing the size/volume of the motor driver 52.

### Fourth Embodiment

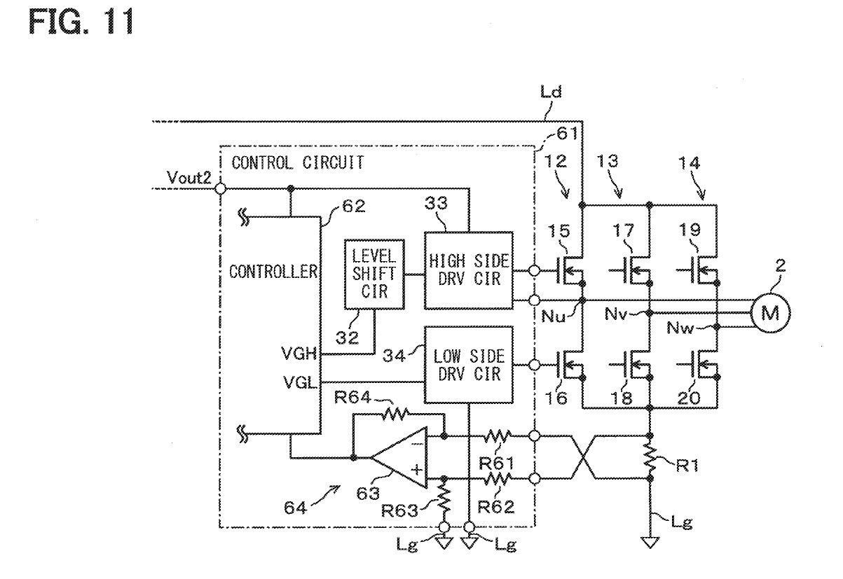

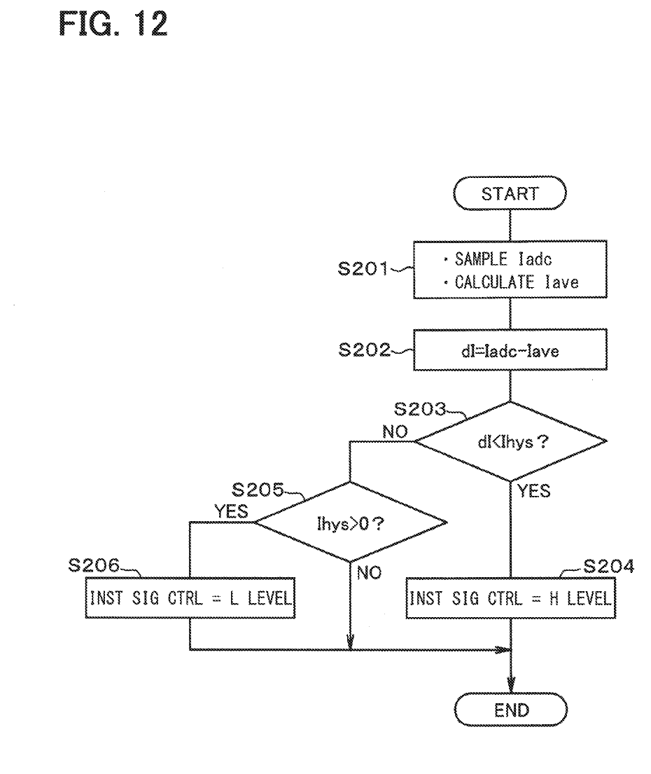

The fourth embodiment is described with reference to FIGS. 11 and 12. As shown in FIG. 11, a control circuit 61 of the present embodiment differs from the control circuit 8 of the first embodiment in FIG. 5 in that the control circuit 61 includes a controller 62 in place of the controller 31, and includes resistors R61, R62, R63, and R64, as well as an operational amplifier (op-amp) 63 in place of the NOR gate 35. The resistors R61, R62, R63, R64, and op-amp 63 may be part of a current amplifier circuit 64. As the control circuit 61 may be used in place of the control circuit 8, the description of the fourth embodiment may reference components of the motor-inverter 1 described in the first embodiment and shown in FIG. 1.

The resistor R61 is connected at a position between one terminal of the resistor R1 and an inverted input terminal of the op-amp 63. The resistor R62 is connected at a position between the other terminal of the resistor R1 and a non-inverted input terminal of the op-amp 63. The resistor R63 is connected at a position between the non-inverted input terminal of the op-amp 63 and the ground line Lg. The resistor R64 is connected at a position between the inverted input terminal and the output terminal of the op-amp 63. By using such a configuration, the current amplifier circuit 64 can amplify the terminal voltage of the resistor R1 that corresponds to the current flowing through the half-bridge circuits 12, 13, and 14.

Just like the controller 31, the controller 62 drives the switching elements 15, 16, 17, 18, 19, and 20.

The controller 62 of the control circuit 61 may include a CPU or like processor, a memory, and one or more inputs/outputs (I/Os). The processor of the controller 62 may be configured to execute a program or instruction set stored in the memory of the controller 62. The execution of the program/instruction set by the CPU of the controller 62 may cause the controller 62 and other components in the control circuit 61 to perform the processes in the process/instruction set. For example, the controller 62, in addition to other components in the control circuit 61, may perform the process shown in FIG. 12. The memory may be, for example, a RAM, a ROM, and a flash memory, and the memory is a substantive, non-transitory computer readable medium for storing programs, instruction sets, data, and other information.

The controller 62 may also include an A/D converter (not shown) having an input port. A current detection signal corresponding to a current output from the current amplifier circuit 64 to flow through the half-bridge circuits 12, 13, and 14 may be input to the A/D converter via the input port. The controller 62 controls the operation mode of the current adjuster circuit 10 based on the current detection signal, i.e., based on the current flowing through the half-bridge circuits 12, 13, and 14. In other words, the controller 62 is configured to change the operating mode of the current adjuster circuit 10 based on the current flowing through the half-bridge circuits 12, 13, and 14.

The current adjuster circuit 10 is configured as a switching power supply circuit similar to the current adjuster circuit 10 of the first embodiment, as shown in FIG. 2. The switching frequency in the switching power supply circuit may be higher than the frequency of the drive signal for driving the switching elements 15, 16, 17, 18, 19, and 20.

The control process performed by the control circuit 61 to control the current adjuster circuit 10 is described with reference to FIG. 12. In the following description, the current flowing through the half-bridge circuits 12, 13, and 14 may be referred to as an inverter current. The control circuit 61 is configured to repeatedly perform the process shown in FIG. 12. The process in FIG. 12 may be described generally as being performed by the control circuit 61, but this may mean that the controller 62, in addition to other components in the control circuit 61, and the motor-inverter 1, 41, 51 are working together to perform the process in FIG. 12.

The process shown in FIG. 12 begins at S201, where the control circuit 61 detects the inverter current value Iadc based on the current detection signal n number of timesat regular time intervals. That is, the control circuit 61 samples the inverter current value ladc n number of times at regular intervals. The number n is a positive integer. An average value lave of the inverter currents is obtained by using these detected values Iadc. That is, at S201, the control circuit 61 samples the detection value Iadc, and calculates the average value lave (i.e., “−SAMPLE Iadc, −CALCULATE lave” at S201 in FIG. 12).

After the control circuit 61 performs the sampling and calculation at S201, the process proceeds to S202, where the control circuit 61 substitutes a value obtained by subtracting the average value lave from the detection value Iadc at a predetermined time for dI. After the control circuit 61 performs the substitution at S202, the process proceeds to S203, where the control circuit 61 determines whether dI is less than Ihys. Ihys is a hysteresis value of a decreasing value of the inverter current.

Here, when the control circuit 61 determines that dI is less than the hysteresis value Ihys, i.e., “YES” at S203, the process proceeds to S204. At Step S204, the control circuit 61 sets the level of the instruction signal CTRL to the H level to make the target value of the output current of the current adjuster circuit 10 the limit value I2H. In such manner, an electric current of the limit value I2H is supplied from the power supply line Ld via the current adjuster circuit 10 to the node Nb, and further, for example, to the capacitor C3 and the power supply circuit 9. After the control circuit 61 sets the instruction signal CTRL to the H level at S204, the process shown in FIG. 12 ends.

On the other hand, when the control circuit 61 determines that dI is equal to or greater than the hysteresis value Ihys, i.e., “NO” at S203, and the process proceeds to S205. At S205, the control circuit 61 determines whether the hysteresis value Ihys is a value greater than 0. When the hysteresis value Ihys is greater than 0, i.e., “YES” at S205, the process proceeds to S206.

At S206, the control circuit 61 sets the level of the instruction signal CTRL to the L level so that the target value of the output current of the current adjuster circuit 10 is the limit value I2L (=0). In such manner, the current supply from the power supply line Ld to the node Nb via the current adjuster circuit 10 is stopped. After the control circuit 61 sets the level of the instruction signal CTRL to the L level at S206, the process shown in FIG. 12 comes to an end.

On the other hand, when the control circuit 61 determines that the hysteresis value Ihys is 0 or less, the control circuit 61 maintains the level of the instruction signal CTRL as is. That is, the control circuit 61 maintains the level of the instruction signal CTRL in the present state to have the dead zone, as described above, for noise suppression. When the control circuit 61 determines that the hysteresis value Ihys is zero or less, i.e., “NO” at S205, the process shown in FIG. 12 ends.

As described above, the control circuit 61 of the present embodiment switches the operating mode of the current adjuster circuit 10 based on the inverter current. Even in such a configuration, just like the first embodiment, the operation of the current adjuster circuit 10 is controllable to increase the current supply amount to the power supply circuit 9 when the current supplied to the motor 2 from the half-bridge circuits 12, 13, and 14 starts to decrease (i.e., changes to be decreasing). As such, the present embodiment is able to achieve the same advantageous effects as those described above for the first embodiment.

The control circuit 61 of the present embodiment detects the inverter current, and controls the operation of the current adjuster circuit 10 based on the detected value of the inverter current. By using such a configuration, the fluctuation of the consumption current of the motor driver 3 occurring in the dead time can be continuously monitored, and, as such, the generation of the ripple current together with the size and magnitude of the ripple current can be continuously monitored. By monitoring the ripple current, the current adjustment operation for absorbing the ripple current can be performed reliably at the appropriate time. By using the configuration of the present embodiment, the ripple current reduction effect can be further improved, while lowering the capacitance of the smoothing capacitor C2. As described above, using capacitors with smaller capacitance values means smaller capacitor sizes, less manufacturing costs, and a reduction to the overall size of the motor-inverter 1, 41, 51.

### Other Embodiments

The present disclosure is not limited to the embodiments described above and illustrated in the drawings, and the motor driver of the present disclosure can be arbitrarily modified, combined, or expanded without departing from the scope thereof. That is, the above-described embodiments may be combined with one another, where the combination of embodiments may include both the addition and subtraction of some of the above-described elements/components from the combination. Elements, features and components of one embodiment may be substituted for elements, features, and components in other embodiments. The numerical values used in the above embodiments are examples only, and non-limiting.

The motor driver of the present disclosure is not limited to driving the motor 2 of a vehicle, but can be used for other purposes. The motor driver of the present disclosure is not limited to the configuration including the three-phase inverter main circuit 7 for driving the motor 2, and may be, for example, provided as at least one configuration such as the one including an H bridge circuit for driving the direct current motor, that includes a half-bridge circuit.

Although the present disclosure has been described in accordance with the embodiments, it is understood that the present disclosure is not limited to the embodiments and structures disclosed therein. The present disclosure may cover various modification examples and equivalent arrangements. Furthermore, various combinations and formations, and other combinations and formations including one or more than one or less than one element may be included in the scope and the spirit of the present disclosure.

The variations of the present disclosure will become apparent to those skilled in the art, and such changes, modifications, and summarized schemes are to be understood as being within the scope of the present disclosure as defined by appended claims.

What is claimed is:

1. A motor driver for driving a motor by receiving a power supply from a direct current power source via a pair of direct current power supply lines, the motor driver comprising:
a half-bridge circuit connected at a position between the pair of direct current power supply lines, the half-bridge circuit having two switching elements, each of the switching elements configured to switch on and off;
a smoothing capacitor connected at a position between the pair of direct current power supply lines;
a power supply circuit configured to receive a supply of electric current from the pair of direct current power supply lines;
a current adjuster circuit configured to adjust a current supply amount to the power supply circuit; and
a control circuit configured to control the half-bridge circuit and the current adjuster circuit, wherein
the control circuit is further configured to control the current adjuster circuit based on an operating state of the half-bridge circuit.

2. The motor driver of claim 1, wherein
the power supply circuit is further configured to provide an operating power supply to the control circuit.

3. The motor driver of claim 1, wherein
the current adjuster circuit is further configured to operate in a plurality of different operating modes, each operating mode in the plurality of different operating modes having a different current supply amount, and wherein
the control circuit is further configured to control the current adjuster circuit to switch from one operating mode to another operating mode when the two switching elements in the half-bridge circuit are switched off.

4. The motor driver of claim 1, wherein
the current adjuster circuit includes a switching power supply circuit configured to switch at a frequency higher than a frequency of a drive signal for driving the two switching elements in the half-bridge circuit, the current adjuster circuit having a plurality of different operating modes, each operating mode in the plurality of different operating modes having a different current supply amount, and wherein
the control circuit is further configured to switch the operating mode of the current adjuster circuit based on an amount of electric current flowing in the half-bridge circuit.

5. The motor driver of claim 1, wherein
the current adjuster circuit is further configured as a bidirectional converter operating in two operation modes, wherein one of the two operation modes steps down a voltage of the direct current power supply line to output a step-down voltage via an output node, and wherein another of the two operation modes boosts the voltage of the output node to regenerate electric current in the direct current power supply line.

6. The motor driver of claim 5, wherein
the power supply circuit is configured as a step-up/step-down switching regulator.
